(19) United States
(12) Patent Application Publication
(10) Pub. No.: US 2021/0334241 A1
(43) Pub. Date: Oct. 28, 2021

(54) NON-DISRPUTIVE TRANSITIONING BETWEEN REPLICATION SCHEMES

(71) Applicant: NetApp, Inc., Sunnyvale, CA (US)

(72) Inventors: Daniel David McCarthy, Erie, CO (US); Austino Nicholas Longo, Lafayette, CO (US); Christopher Clark Corey, Boulder, CO (US); Sneheet Kumar Mishra, Lafayette, CO (US)

(21) Appl. No.: 16/858,294

(22) Filed: Apr. 24, 2020

(51) Int. Cl. G06F 16/182; G06F 16/16; G06F 12/02

(52) U.S. Cl. CPC G06F 16/184; G06F 16/162; G06F 2212/608; G06F 12/0253; G06F 16/164

(57) ABSTRACT

A technique transitions data blocks of volumes served by storage nodes of a storage cluster from an old data protection scheme (DPS) to a new DPS in a non-disruptive manner. Slice services of the storage nodes forward the data blocks associated with write requests to the block services for storage on storage devices of the nodes. Mapping of volume logical block addresses to block identifiers are contained in slice files, wherein there is a single slice file for each volume. To transition a volume between the old and new DPSs, the slice service tags the data blocks with the new DPS when forwarding new write requests to the block services. In accordance with a background transitioning process, the slice service also retrieves every data block referenced by the to slice file and then resends the data to the block service with the new DPS.

### BACKGROUND

### Technical Field

The present disclosure relates to protection of data served by storage nodes of a storage cluster and, more specifically, to transitioning between data protection schemes for data served by the storage nodes of the cluster.

### Background Information

A plurality of storage nodes organized as a storage cluster may provide a distributed storage architecture configured to service storage requests issued by one or more clients of the storage cluster. The storage requests are directed to data stored on storage devices coupled to one or more of the storage nodes. The data served by the storage nodes may be distributed across multiple storage units embodied as persistent is storage devices, such as hard disk drives, solid state drives, flash memory systems, or other storage devices. The storage nodes may organize the data stored on the devices as client-created, logical volumes (volumes) accessible as logical units (LUNs). Each volume may be implemented as a set of data structures, such as data blocks that store data for the volume and metadata blocks that describe the data of the volume. For example, the metadata may describe, e.g., identify, storage locations on the devices for the data.

Specifically, a volume, such as a LUN, may be divided into data blocks. To support increased durability of data, the data blocks of the volume may be protected by replication of the blocks among the storage nodes. That is, to ensure data integrity (availability) in the event of node failure, a data protection scheme (DPS), such as replicating blocks, may be employed for the volume within the cluster. A storage cluster employing a per volume DPS, provides flexibility for the client to change (transition) the volume from one DPS to another DPS. One common approach to changing the DPS on a volume is to create a new volume with the desired DPS and copy the data from an existing volume. However, this approach is disruptive and requires, among other things, the client to reconnect to the new volume to gain the benefit of the new DPS.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of storage nodes interconnected as a storage cluster;

FIG. 2 is a block diagram of a storage node;

FIG. 3A is a block diagram of a storage service of the storage node;

FIG. 3B is a block diagram of an exemplary embodiment of the storage service;

FIG. 4 illustrates a write path of the storage node;

FIG. 5 is a block diagram illustrating details of a block identifier; and

FIG. 6 illustrates an example for non-disruptive transitioning of a volume between data protection schemes.

### OVERVIEW

The embodiments described herein are directed to a technique configured to transition data blocks of logical volumes (“volumes”) served by storage nodes of a storage cluster from a first data protection scheme (DPS) to a second DPS in a non-disruptive manner. A storage service implemented in each node includes a metadata layer having one or more metadata (slice) services configured to process and store metadata describing the data blocks, and a block service layer having one or more block services configured to process (deduplicate) and store the data blocks on storage devices of the node. The slice services forward the data blocks associated with write requests to the block services for storage on the storage devices. The block services are configured to provide maximum degrees of data protection as offered by the different DPSs and deduplicate the data blocks across a volume (as appropriate) when transitioning between different DPSs.

In an embodiment, the slice services store the mapping of logical block addresses (LBAs) of the volume to block identifiers (IDs) of the data blocks, whereas the block services store a mapping of block IDs to disk locations for storage of the data blocks. The mapping of volume LBAs to block IDs are contained in slice files, wherein there is a single slice file for each volume. Each slice file has an associated DPS, e.g., double replication, triple replication, or erasure coding (EC). When a block is forwarded by the slice services to the block services for storage, the slice services also pass along, as an indication (e.g., as a tag), the DPS used for that block (the DPS of the volume from which the write request originated). The block services then store the data block as well as the DPS tag associated with the block.

To transition a volume between the first (old) and second (new) DPSs, a slice service tags data blocks with the new DPS, such as when forwarding the blocks of new write requests to the block services. This ensures that all write requests after this time, e.g., t1, are for the new DPS. In accordance with a background transitioning process to convert existing blocks of the volume to use the new DPS, the slice service reads (retrieves) every data block referenced by the slice file and, if appropriate, resends the data block tagged with the new DPS to the block services. The block services store these new data blocks and deduplicate the blocks as appropriate. If the transitioning process is interrupted for any reason, the slice service starts over at the beginning of the slice file and relies on the deduplication capabilities of the block services to process any blocks that may have previously been sent.

Data blocks that are no longer in use by any volumes are cleaned up via a garbage collection (GC) process. During the time between t1 and when all data blocks have been sent to the block services, e.g., t2, the slice service inserts the block IDs for the volume into Bloom filters configured separately for both the old DPS and the new DPS. That is, the slice service sends different Bloom filters for each DPS enabled on the cluster to the block services. Any GC processing that occur after t2 only has block IDs inserted to the Bloom filters for the new DPS. During this GC processing after t2, the block services remove the block IDs from the Bloom filters for the old DPS in use by the volume (assuming those blocks are not in use by another volume with the old DPS). When the old DPS is no longer in use for a block, the block services react accordingly by either discarding (deleting) the block or optimizing storage efficiency for the block. For example, if the GC process determines that a fewer number of DPSs are using a block, the block services optimize storage efficiency through deduplication and/or erasure coding, accordingly. After GC, the system operates as if all blocks were written with the new DPS.

Advantageously, the technique described herein is directed to making the transition from the first DPS to the second DPS non-disruptively, i.e., a new volume is not required, the client is not required to disconnect and then reconnect to the volume, and there is substantially no performance impact.

### DESCRIPTION

Storage Cluster

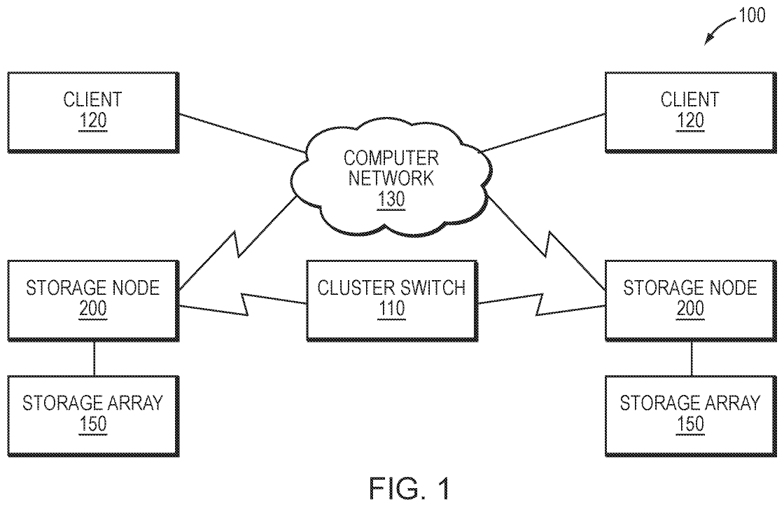

FIG. 1 is a block diagram of a plurality of storage nodes 200 interconnected as a storage cluster 100 and configured to provide storage service for information, i.e., data is and metadata, organized and stored on storage devices of the cluster. The storage nodes 200 may be interconnected by a cluster switch 110 and include functional components that cooperate to provide a distributed, scale-out storage architecture of the cluster 100. The components of each storage node 200 include hardware and software functionality that enable the node to connect to and service one or more clients 120 over a computer network 130, as well as to a storage array 150 of storage devices, to thereby render the storage service in accordance with the distributed storage architecture.

Each client 120 may be embodied as a general-purpose computer configured to interact with the storage node 200 in accordance with a client/server model of information delivery. That is, the client 120 may request the services of the node 200, and the node may return the results of the services requested by the client, by exchanging packets over the network 130. The client may issue packets including file-based access protocols, such as the Network File System (NFS) and Common Internet File System (CIFS) protocols over the Transmission Control Protocol/Internet Protocol (TCP/IP), when accessing information on the storage node in the form of storage objects, such as files and directories. However, in an embodiment, the client 120 illustratively issues packets including block-based access protocols, such as the Small Computer Systems Interface (SCSI) protocol encapsulated over TCP (iSCSI) and SCSI encapsulated over FC (FCP), when accessing information in the form of storage objects such as logical units (LUNs).

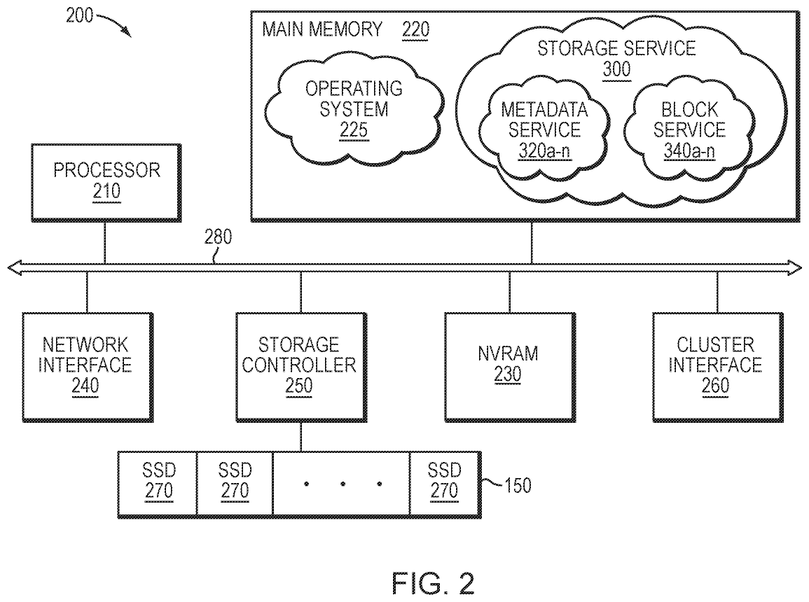

FIG. 2 is a block diagram of storage node 200 illustratively embodied as a computer system having one or more processing units (processors) 210, a main memory 220, a non-volatile random access memory (NVRAM) 230, a network interface 240, one or more storage controllers 250 and a cluster interface 260 interconnected by a system bus 280. The network interface 240 may include one or more ports adapted to couple the storage node 200 to the client(s) 120 over computer network 130, which may include point-to-point links, wide area networks, virtual private networks implemented over a public network (Internet) or a shared local area network. The network interface 240 thus includes the mechanical, electrical and signaling circuitry needed to connect the storage is node to the network 130, which may embody an Ethernet or Fibre Channel (FC) network.

The main memory 220 may include memory locations that are addressable by the processor 210 for storing software programs and data structures associated with the embodiments described herein. The processor 210 may, in turn, include processing elements and/or logic circuitry configured to execute the software programs, such as one or more metadata services 320a-n and block services 340a-n of storage service 300, and manipulate the data structures. An operating system 225, portions of which are typically resident in memory 220 (in-core) and executed by the processing elements (e.g., processor 210), functionally organizes the storage node by, inter alia, invoking operations in support of the storage service 300 implemented by the node. A suitable operating system 225 may include a general-purpose operating system, such as the UNIX® series or Microsoft Windows® series of operating systems, or an operating system with configurable functionality such as microkernels and embedded kernels. However, in an embodiment described herein, the operating system is illustratively the Linux® operating system. It will be apparent to those skilled in the art that other processing and memory means, including various computer readable media, may be used to store and execute program instructions pertaining to the embodiments herein. Also, while the embodiments herein are described in terms of software programs, services, code, processes, and computer applications (e.g., stored in memory), alternative embodiments also include the code, services, processes and programs being embodied as logic and/or modules consisting of hardware, software, firmware, or combinations thereof.

The storage controller 250 cooperates with the storage service 300 implemented on the storage node 200 to access information requested by the client 120. The information is preferably stored on storage devices such as internal solid-state drives (SSDs) 270, illustratively embodied as flash storage devices, as well as SSDs of the external storage array 150 (i.e., an additional storage array attached to the node). In an embodiment, the flash storage devices may be block-oriented devices (i.e., drives accessed as blocks) based on NAND flash components, e.g., single-level-cell (SLC) flash, multi-level-cell (MLC) flash or triple-level-cell (TLC) flash and the like, although it will be understood to those skilled in the art that other block-oriented, non-volatile, solid-state electronic devices (e.g., drives based on storage class memory components) or rotating magnetic storage devices (e.g., hard disk drives) may be advantageously used with the embodiments described herein. The storage controller 250 may include one or more ports having I/O interface circuitry that couples to the SSDs 270 over an I/O interconnect arrangement, such as a serial attached SCSI (SAS) and serial ATA (SATA) topology.

The cluster interface 260 may include one or more ports adapted to couple the storage node 200 to the other node(s) of the cluster 100. In an embodiment, dual 10 Gbps Ethernet ports may be used for internode communication, although it will be apparent to those skilled in the art that other types of protocols and interconnects may be utilized within the embodiments described herein. The NVRAM 230 may include a back-up battery or other built-in last-state retention capability (e.g., non-volatile semiconductor memory such as storage class memory) that is capable of maintaining data in light of a failure to the storage node and cluster environment.

Storage Service

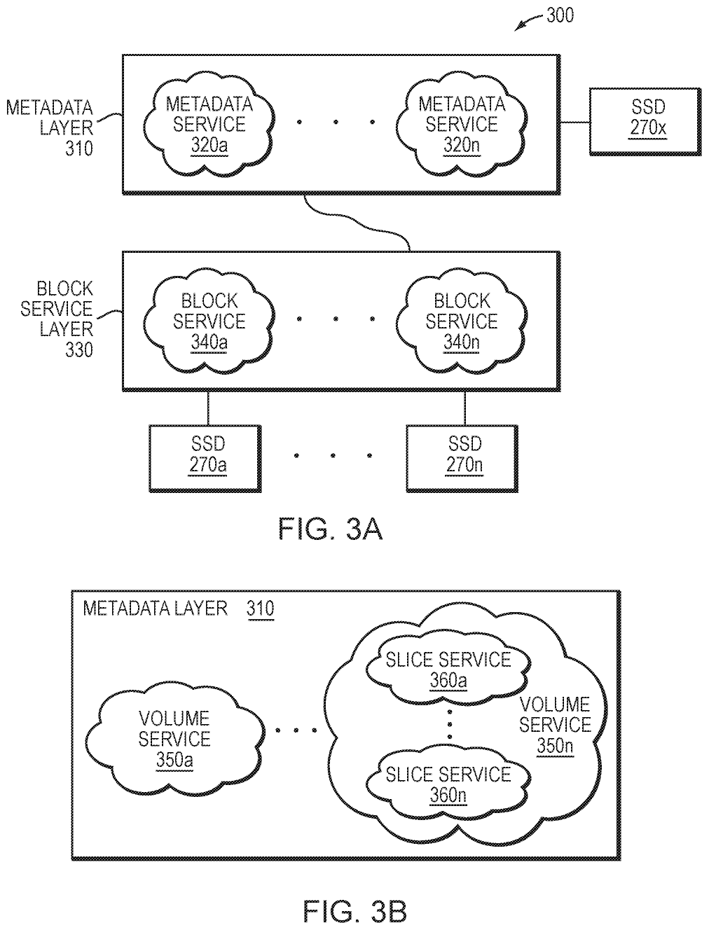

FIG. 3A is a block diagram of the storage service 300 implemented by each storage node 200 of the storage cluster 100. The storage service 300 is illustratively organized as one or more software modules or layers that cooperate with other functional components of the nodes 200 to provide the distributed storage architecture of the cluster 100. In an embodiment, the distributed storage architecture aggregates and virtualizes the components (e.g., network, memory, and compute resources) to present an abstraction of a single storage system having a large pool of storage, i.e., all storage, including internal SSDs 270 and external storage arrays 150 of the nodes 200 for the entire cluster 100. In other words, the architecture consolidates storage throughout the cluster to enable storage of the LUNs, each of which may be apportioned into one or more logical volumes (“volumes”) having a typical logical block size of either 4096 bytes (4 KB) or 512 bytes. Each volume may be further configured with properties such as size (storage capacity) and performance settings (quality of service), as well as access control, and may be is thereafter accessible (i.e., exported) as a block storage pool to the clients, preferably via iSCSI and/or FCP. Both storage capacity and performance may then be subsequently “scaled out” by growing (adding) network, memory and compute resources of the nodes 200 to the cluster 100.

Each client 120 may issue packets as input/output (I/O) requests, i.e., storage requests, to access data of a volume served by a storage node 200, wherein a storage request may include data for storage on the volume (i.e., a write request) or data for retrieval from the volume (i.e., a read request), as well as client addressing in the form of a logical block address (LBA) or index into the volume based on the logical block size of the volume and a length. The client addressing may be embodied as metadata, which is separated from data within the distributed storage architecture, such that each node in the cluster may store the metadata and data on different storage devices (e.g., data on SSDs 270a-n and metadata on SSD 270x) coupled to the node. To that end, the storage service 300 implemented in each node 200 includes a metadata layer 310 having one or more metadata services 320a-n configured to process and store the metadata, e.g., on SSD 270x, and a block server layer 330 having one or more block services 340a-n configured to process and store the data, e.g., on the SSDs 270a-n. For example, the metadata services 320a-n map between client addressing (e.g., LBAs or indexes) used by the clients to access the data on a LUN (e.g., a volume) and block addressing (e.g., block identifiers) used by the block services 340a-n to store and/or retrieve the data on the volume, e.g., of the SSDs.

FIG. 3B is a block diagram of an alternative embodiment of the storage service 300. When issuing storage requests to the storage nodes, clients 120 typically connect to volumes (e.g., via indexes or LBAs) exported by the nodes. To provide an efficient implementation, the metadata layer 310 may be alternatively organized as one or more volume services 350a-n, wherein each volume service 350 may perform the functions of a metadata service 320 but at the granularity of a volume, i.e., process and store the metadata for the volume. However, the metadata for the volume may be too large for a single volume service 350 to process and store; accordingly, multiple slice services 360a-n may be associated with each volume service 350. The metadata for the volume is may thus be divided into slices and a slice of metadata may be stored and processed on each slice service 360. In response to a storage request for a volume, a volume service 350 determines which slice service 360a-n contains the metadata for that volume and forwards the request to the appropriate slice service 360.

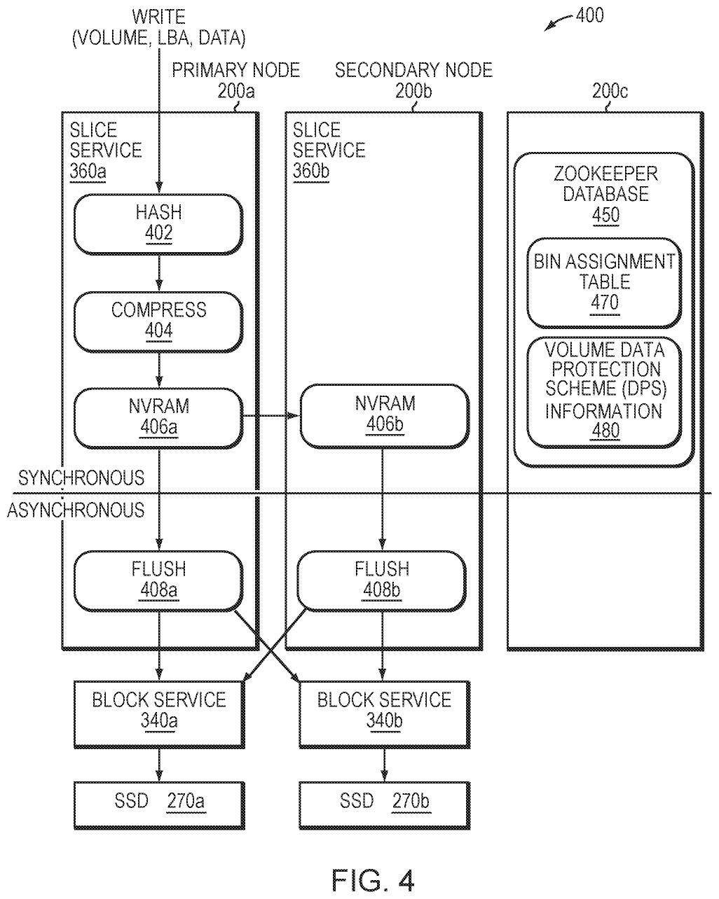

FIG. 4 illustrates a write path 400 of a storage node 200 for storing data on a volume of a storage array 150. In an embodiment, an exemplary write request issued by a client 120 and received at a storage node 200 (e.g., primary node 200a) of the cluster 100 may have the following form:

write (volume, LBA, data)

wherein the volume specifies the logical volume to be written, the LBA is the logical block address to be written, and the data is the actual data to be written.

Illustratively, the data received by a slice service 360a of the storage node 200a is divided into 4 KB block sizes. At box 402, each 4 KB data block is hashed using a cryptographic hash function to generate a 128-bit (16 B) hash value (recorded as a block identifier (ID) of the data block); illustratively, the block ID is used to address (locate) the data on the internal SSDs 270 as well as the external storage array 150. A block ID is thus an identifier of a data block that is generated based on the content of the data block. The cryptographic hash function, e.g., Skein algorithm, provides a satisfactory random distribution of bits within the 16B hash value/block ID employed by the technique. At box 404, the data block is compressed using a compression algorithm, e.g., LZW (Lempel-Zif-Welch), and, at box 406a, the compressed data block is stored in NVRAM 230. Note that, in an embodiment, the NVRAM 230 is embodied as a write cache. Each compressed data block is then synchronously replicated to the NVRAM 230 of one or more additional storage nodes (e.g., secondary storage node 200b) in the cluster 100 for data protection (box 406b). An acknowledgement is returned to the client when the data block has been safely and persistently stored in the NVRAM 230a,b of the multiple storage nodes 200a,b of the cluster 100.

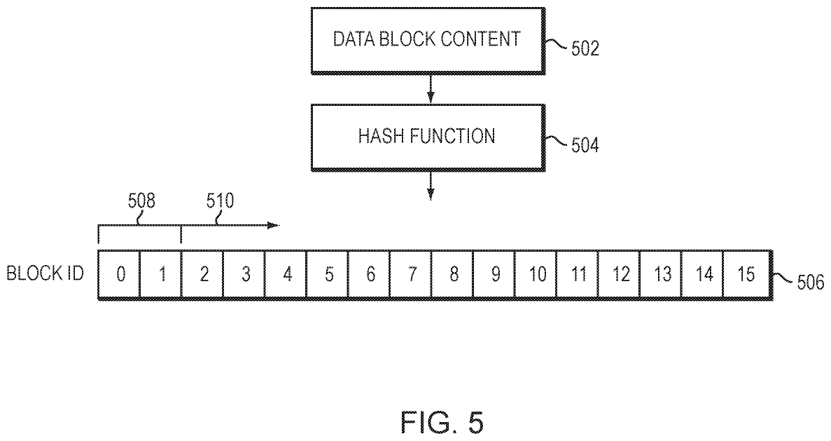

FIG. 5 is a block diagram illustrating details of a block identifier. In an embodiment, content 502 for a data block is received by storage service 300. As is described above, the received data is divided into data blocks having content 502 that may be processed using hash function 504 to determine block identifiers (IDs). That is, the data is divided into 4 KB data blocks, and each data block is hashed to generate a 16B hash value recorded as a block ID 506 of the data block; illustratively, the block ID 506 is used to locate the data on one or more storage devices 270 of the storage array 150. The data is illustratively organized within bins that are maintained by a block service 340a-n for storage on the storage devices. A bin may be derived from the block ID for storage of a corresponding data block by extracting a predefined number of bits from the block ID 506.

In an embodiment, the bin may be divided into buckets or “sublists” by extending the predefined number of bits extracted from the block ID. For example, a bin field 508 of the block ID may contain the first two (e.g., most significant) bytes (2B) of the block ID 506 used to generate a bin number (identifier) between 0 and 65,535 (depending on the number of 16 bits used) that identifies a bin. The bin identifier may also be used to identify a particular block service 340a-n and associated SSD 270. A sublist field 510 may then contain the next byte (1B) of the block ID used to generate a sublist identifier between 0 and 255 (depending on the number of 8 bits used) that identifies a sublist with the bin. Dividing the bin into sublists facilitates, inter alia, network transfer (or syncing) of data among block services in the event of a failure or crash of a storage node. The number of bits used for the sublist identifier may be set to an initial value, and then adjusted later as desired. Each block service 340a-n maintains a mapping between the block ID and a location of the data block on its associated storage device/SSD, i.e., block service drive (BSD).

Illustratively, the block ID (hash value) may be used to distribute the data blocks among bins in an evenly balanced (distributed) arrangement according to capacity of the SSDs, wherein the balanced arrangement is based on “coupling” between the SSDs, i.e., each node/SSD shares approximately the same number of bins with any other node/SSD that is not in a same failure domain, i.e., protection domain, of the cluster. As a result, the data blocks are distributed across the nodes of the cluster based on content (i.e., content driven distribution of data blocks). This is advantageous for rebuilding data in is the event of a failure (i.e., rebuilds) so that all SSDs perform approximately the same amount of work (e.g., reading/writing data) to enable fast and efficient rebuild by distributing the work equally among all the SSDs of the storage nodes of the cluster. In an embodiment, each block service maintains a mapping of block ID to data block location on storage devices (e.g., internal SSDs 270 and external storage array 150) coupled to the node.

Illustratively, bin assignments may be stored in a distributed key-value store across the cluster. Referring again to FIG. 4, the distributed key-value storage may be embodied as, e.g., a “zookeeper” database 450 configured to provide a distributed, shared-nothing (i.e., no single point of contention and failure) database used to store bin assignments (e.g., a bin assignment table) and configuration information that is consistent across all nodes of the cluster. In an embodiment, one or more nodes 200c has a service/process associated with the zookeeper database 450 that is configured to maintain the bin assignments (i.e., mappings) in connection with a data structure, e.g., bin assignment table 470. Illustratively the distributed zookeeper is resident on up to, e.g., five (5) selected nodes in the cluster, wherein all other nodes connect to one of the selected nodes to obtain the bin assignment information. Thus, these selected “zookeeper” nodes have replicated zookeeper database images distributed among different failure domains of nodes in the cluster so that there is no single point of failure of the zookeeper database. In other words, other nodes issue zookeeper requests to their nearest zookeeper database image (zookeeper node) to obtain current bin assignments, which may then be cached at the nodes to improve access times.

For each data block received and stored in NVRAM 230a,b, the slice services 360a,b compute a corresponding bin number and consult the bin assignment table 470 to identify the SSDs 270a,b to which the data block is written. At boxes 408a,b, the slice services 360a,b of the storage nodes 200a,b then issue store requests to asynchronously flush copies of the compressed data block to the block services 340a,b associated with the identified SSDs. An exemplary store request issued by each slice service 360a,b and received at each block service 340a,b may have the following form:

store (block ID, compressed data)

The block service 340a,b for each SSD 270a,b (or storage devices of external storage array 150) determines if the block service has previously stored a copy of the data block. If so, the block service deduplicates the data for storage efficiency. Notably, the block services are configured to provide maximum degrees of data protection offered by the various data protection schemes and still deduplicate the data blocks across the volumes despite the varying data protection schemes among the volumes.

If the copy of the data block has not been previously stored, the block service 340a,b stores the compressed data block associated with the block ID on the SSD 270a,b. Note that the block storage pool of aggregated SSDs is organized by content of the block ID (rather than when data was written or from where it originated) thereby providing a “content addressable” distributed storage architecture of the cluster. Such a content-addressable architecture facilitates deduplication of data “automatically” at the SSD level (i.e., for “free”), except for at least two copies of each data block stored on at least two SSDs of the cluster. In other words, the distributed storage architecture utilizes a single replication of data with inline deduplication of further copies of the data, i.e., there are at least two copies of data for redundancy purposes in the event of a hardware failure.

When providing data protection in the form of replication (redundancy), a slice service 360a,n of the storage node 200 generates one or more copies of a data block for storage on the cluster. Illustratively, the slice service computes a corresponding bin number for the data block based on the cryptographic hash of the data block and consults (i.e., looks up) the bin assignment table 470 to identify the storage nodes to which the data block is to be stored (i.e., written). In this manner, the bin assignment table tracks copies of the data block within the cluster. The slice services of the additional nodes then issue store requests to asynchronously flush copies of the data block to the block services 340a,n associated with the identified storage nodes.

In an embodiment, the volumes are assigned to the slice services depending upon the data protection scheme (DPS). For example, when providing triple replication protection of data, the slice service initially generates three copies of the data block (i.e., is an original copy 0, a copy 1 and a copy 2) by synchronously copying (replicating) the data block to persistent storage (e.g., NVRAM) of additional slice services of storage nodes in the cluster for sending to block services. The copies of the data block are then asynchronously flushed to respective block services. Accordingly, a block of a volume may be assigned to an original replica 0 (RO) block service, as well as to a primary replica 1 (R1) block service and a secondary replica 2 (R2) block service. Each replicated data block is illustratively organized within the allotted bin that is maintained by the block services of each of the nodes for storage on the storage devices. Each bin is assigned to one or more block services based on a maximum redundancy of the DPSs employed, e.g., for a triple replication DPS, three block services are assigned to each bin. Each slice service computes a corresponding bin number for the data block and consults (e.g., looks up using the bin number as an index) the bin assignment table 470 to identify the storage nodes to which the data block is written.

The data block is also associated (tagged) with an indication of its corresponding DPS. For instance, data blocks of a volume with double replication DPS (i.e., data blocks with one replica each) may have data blocks assigned to two block services because the R0 data block is assigned to a R0 block service and the R1 data block is assigned to the same bin but hosted on a different block service, i.e., R1 block service. Illustratively, a data block may belong to a first volume with double replication DPS and a different second volume with triple replication DPS. The technique described herein ensures that there are sufficient replicas of the data block (“data replicas”) to satisfy the volume with the higher data integrity guarantee. i.e., highest DPS. The slice services of the nodes may then issue store requests based on the DPS to asynchronously flush the data blocks of the data replicas (e.g., copies R0, R1 for double replication or copies R0-R2 for triple replication) to the block services associated with the identified storage nodes.

When providing data protection in the form of erasure coding, the block services may select data blocks to be erasure coded. When using erasure coding, the storage node uses an erasure code to algorithmically generate encoded blocks in addition to the data blocks. In general, an erasure code algorithm, such as Reed Solomon, uses n blocks of is data to create an additional k blocks (n+k), where k is the number of encoded blocks of replication or “parity” used for data protection. Erasure coded data allows missing blocks to be reconstructed from any n blocks of the n+k blocks. For example, an 8+3 erasure coding scheme, i.e. n=8 and k=3, transforms eight blocks of data into eleven blocks of data/parity (i.e., the 8 data blocks and 3 parity blocks). In response to a read request, the data may then be reconstructed (if necessary) from any eight of the eleven blocks.

Notably, a read is preferably performed from the eight unencoded data blocks and reconstruction used when one or more of the unencoded data blocks is unavailable.

A set of data blocks may then be grouped together to form a write group for erasure coding (EC). Illustratively, write group membership is guided by varying bin groups so that the data is resilient against failure, e.g., assignment based on varying a subset of bits in the bin identifier. The slice services route data blocks of different bins (e.g., having different bin groups) and replicas to their associated block services. The implementation varies with an EC scheme selected for deployment (e.g., 4 data blocks and 2 encoded blocks for correction, 4+2 EC). The block services assign the data blocks to bins according to the cryptographic hash and group a number of the different bins together based on the EC scheme deployed, e.g., 4 bins may be grouped together in a 4+2 EC scheme and 8 bins may be grouped together in an 8+1 EC scheme. The write group of blocks from the different bins may be selected from data blocks temporarily spooled according to the bin. That is, the data blocks of the different bins of the write group are selected from the pool of temporarily spooled blocks by bin so as to represent a wide selection of bins with differing failure domains resilient to data loss. Note that only the data blocks (i.e., unencoded blocks) need to be assigned to a bin, while the encoded blocks may be simply associated with the write group by reference to the data blocks of the write group.

In an example, consider that a block has a first DPS using double replication and a second DPS using 4+1 EC so that each scheme has a single redundancy against unavailability of any one block. Blocks may be grouped in sets of 4 and the EC scheme applied to form an encoded block (e.g., a parity block), yielding 5 blocks for every set of 4 blocks instead of 4 blocks and 4 duplicates (i.e., 8 total blocks) for the replication scheme. Notably, the technique described herein permits a DPS (e.g., 4+1 EC or double replication) to be selected on a block-by-block basis based on a set of capable DPSs satisfying a same level of redundancy for the block according to a policy. For example, a performance-oriented policy may select a double replication DPS in which an unencoded copy of a block is always available without a need for parity computation. On the other hand, a storage space-oriented policy may select an EC DPS to eliminate replicas so as to use storage more efficiently. Illustratively, the 4 duplicates from the above double replication DPS and 5 blocks from the 4+1 EC DPS (9 blocks total) may be consumed to store the 4 data blocks. As such, to maintain a single failure redundancy, 4 of the duplicate blocks may be eliminated, thereby reducing storage space of the storage nodes while maintaining the same data integrity guarantee against a single failure. In an embodiment, the policy may be selected by an administrator upon creation of a volume.

In order to satisfy the data integrity guarantees while increasing available storage space (i.e., reducing unnecessary storage of duplicate data blocks), the storage nodes perform periodic garbage collection (GC) for data blocks to increase storage in accordance with currently applicable DPSs. Slice services of the storage nodes manage the metadata for each volume in slice files and, at garbage collection time, generate lists or Bloom filters for each DPS. The Bloom filters identify data blocks currently associated with the DPS and the block services use the Bloom filters to determine whether the DPSs for any data blocks that they manage may have changed.

If the applicable DPS(s) for a data block has changed, the block service optimizes (e.g., reduces redundant information) storage of the data block in accordance with the currently applicable schemes so as to maintain a level of data integrity previously associated with the changed block. That is, a same level of redundancy of data associated with the changed block is maintained when redundancy schemes are changed. For example, a data block may have been previously associated with both a double replication DPS and a triple replication DPS. To comply with the triple replication DPS, an original and two copies of the data block (i.e., replica 0, replica 1, and replica 2) have been stored. If the triple replication DPS is no longer applicable to the data block, the third copy of the data block may be removed, leaving only the replicas 0 and 1 stored to is comply with the data integrity guarantee of the remaining double replication DPS.

If the DPS associated with the data block is further altered to an EC DPS and a policy of storage space efficiency is chosen, the data block may be included in a write group with single parity protection and the second copy (i.e., replica 1) of the data block may be removed such that the data block has a same level of redundancy as double replication DPS. On the other hand, if a performance policy is chosen, replica 1 may not be eliminated. Notably, a change of DPS is selected from the set of capable protection schemes available for the block. Examples of improving storage utilization for various data protection schemes that may be advantageously employed with the embodiments described herein are disclosed in co-pending and commonly-assigned U.S. patent application Ser. No. 16/601,978, filed Oct. 15, 2019, titled Improving Available Storage Space with Varying Data Redundancy Schemes, which application is hereby incorporated by reference as though fully set forth herein.

Often, it may be desirable for a client to change the DPS on a volume in order to increase/decrease reliability, efficiency, degraded read performance, or the like. One common approach to changing the DPS on a volume is to create a new volume with the desired. DPS and copy the data from an existing volume. However, this approach is disruptive and requires, among other things, the client to reconnect to the new volume to gain the benefit of the new DPS.

Non-disruptive Transitioning Between Data Protection Schemes

The embodiments described herein are directed to a technique configured to transition data blocks of a volume served by storage nodes of a storage cluster from a first DPS to a second DPS in a non-disruptive manner. As noted, the slice services store the mapping of LB. As of the volume to block IDs of the data blocks, whereas the block to services store a mapping of block IDs to disk locations for storage of the data blocks. The mapping of volume LBAs to block IDs are contained in slice files, wherein there is a single slice file for each volume. Each slice file has an associated DPS (e.g., double replication, triple replication, or EC) and each slice service has an associated copy of the slice file depending upon the DPS. When a block is forwarded to the block services for is storage by the slice services, the slice services also pass along, as an indication (e.g., as a tag), the DPS used for that block (the DPS of the volume from which the write request originated). The block services then store the data block as well as the DPS tag associated with the block.

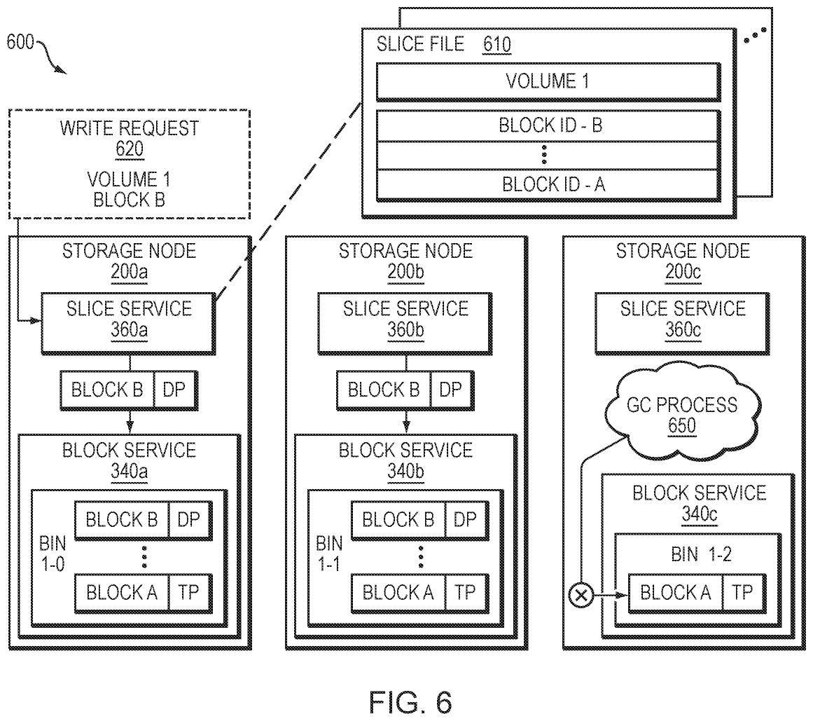

FIG. 6 illustrates an example 600 for non-disruptive transitioning of a volume between data protection schemes. Each storage node 200a-c includes a slice service 360a-c and a block service 340a-c, respectively. Each block service 340a-c hosts a bin 1-0, a bin 1-1, and a bin 1-2, respectively, wherein each bin is assigned to and managed by its corresponding block service. In an embodiment, the slice service 360a of storage node 200a functions as a managing (original) slice service and handles requests, such as write requests, from the client (i.e., client-facing slice service). To that end, the slice service 360a manages metadata in a slice file 610 that is replicated across the storage nodes 200b,c to the slice services 360b and 360c. As noted, the slice file 610 has a one-to-one relationship (i.e., association) with the volume and, as such stores metadata for the volume, e.g., Volume 1. The slice file 610 also has an associated DPS configured on a per volume basis, e.g., volume 1 is configured with a DPS, such as triple replication. In an embodiment, a plurality of copies of slice files 610 per volume are maintained each having the block ids corresponding to one of the replicas (e.g., a first slice file has block ids for replica 0, a second sliced file has block ids for replica 1, and so on).

To support the volume DPS, replicas of bins (“bin replicas”) are generated and assigned across the block services of the cluster. Since the volume DPS is triple replication, two replicas of each bin are created and assigned to block services in addition to a bin which hosts a replica 0 copy of a data block. For example, bin 1-0, which is illustratively maintained by block service 340a, hosts an unencoded version/replica 0 copy of the block. Bin 1-1, which is illustratively maintained by the block service 340b, hosts a replica 1 (R1) copy of the data block as indicated by the “−1” of the “hosts replica” notation “bin 1-1.” Similarly, bin 1-2, which is illustratively maintained by block service 340c, hosts a replica 2 (R2) copy of the data block as indicated by the “−2” of the hosts replica notation “bin 1-2.”

A write request 620 from a client includes a data block and identifies a volume on which the data is to be stored. As write requests are received for the volume, the slice service 360a consults the zookeeper database 450 to generate copies of the associated data blocks in accordance with the DPS for the volume (e.g., triple replication) as indicated by volume DPS information 480 of the database and then updates the slice file accordingly. For example, assume a write request previously received from a client includes a data block (Block A) for storage on a volume (Volume 1) protected by triple replication (TP) DPS. The slice service 360a synchronously copies Block A to NVRAM 230 of slice services 360b,c and updates the slice file 610 accordingly with indications that Block A is contained in Volume 1.

The slice service 360a also notifies slice services 360b and 360c of the update to the slice file 610 and provides the metadata for the update. When Block A is flushed (forwarded) to the block services 340a-c for storage, the slice services 360a-c also pass along (e.g., as a tag) the DPS for that block (the DPS of the volume from which the write request originated). The block services then store the data block as well as the DPS tag associated with the block. Accordingly, bin 1-0 hosts (stores) a R0 copy of the Block A as well as the DPS tag for block A (e.g., TP). In addition, bin 1-1 stores a R1 copy of the Block A as well as the TP tag and bin 1-2 stores a R2 copy of Block A along with the TP tag.

To transition a volume (slice) between the first (old) and second (new) DPSs, the slice service 360a switches the old DPS used with the existing data blocks of the volume to the new DPS when forwarding the blocks of new incoming write requests to the block services. Illustratively, transitioning between the old and new DPS is performed atomically at a point in time (t1) by, e.g., updating the volume DPS information 480 in the zookeeper database 450 to indicate the new DPS in sequence with tagging the data blocks of all write requests after time t1 with the new DPS. For example, assume that at time t1, the slice service 360a receives a command to transition Volume 1 from the old (TP) DPS to a new (double replication, DP) DPS and, in response, updates the volume DPS information 480 in the zookeeper database 450 accordingly. After time t1, the slice service 360a receives a new incoming write request 620 identifying the volume (e.g., Volume 1) on which the associated data block (i.e., Block B) is to be stored. The slice service 360a consults the volume DPS information 480 in the zookeeper database 450 and tags the Block B with the new DPS (i.e., DP).

Since the DPS is double replication, the slice service 360a synchronously copies Block B to NVRAM 230 of only slice service 360b and updates the metadata of the slice file 610 accordingly by indicating that Block B is associated with Volume 1. Slice services 360a,b thereafter asynchronously flush their tagged copies of Block B tagged DP to the block services 340a,b, which store the copies (along with their DP tags) as replicas R0 and R1, respectively. Note that additional (or fewer) replicas of the bins may be generated for assignment to the block services to support the new DPS of the volume as appropriate for the new DPS. Note also that, in an embodiment, the data blocks may be tagged with the appropriate DPS using a data structure organized on a per block granularity to reflect each block ID of the volume with its corresponding DPS. Alternatively, an optimization of the data structure organization may involve the slice service “batching” a group of similarly tagged data blocks for flushing to the block services.

In accordance with the technique, the slice file 610 maintains both the old DPS and new DPS tags as attributes (i.e., non-exclusive “states”) of the data blocks contained in the volume for GC purposes. That is, a data block DPS tag acts as a non-exclusive attribute (i.e., “state”) that may transition from the old DPS to the new DPS. Notably, a data block may be tagged with both the old. DPS and the new DPS when the data block is shared among volumes with different DPSs. Once the transition is atomically performed for the volume to the new DPS for data blocks associated with new incoming write to requests, the technique addresses the existing (previous) data blocks tagged with the old DPS.

Specifically, the slice service 360a traverses (walks) the slice file 610 for Volume 1 to read (retrieve) each data block tagged with the old DPS and retags the block and its associated block ID with the new DPS via a background transitioning process. When increasing redundancy (e.g., increasing a number of block replicas), the primary slice service 350a forwards the retagged data block and block ID to the appropriate block services; alternatively, an optimization of the technique may involve the slice services forwarding only the retagged block IDs (i.e., without the data block itself) to the block services, which already have a copy of the data block. When decreasing redundancy (e.g., decreasing a number of block replicas), a slice service may drop (e.g., mark as deleted) its copy of the slice file corresponding to the decreased replication. The block services store these new blocks and optimize the blocks for storage efficiency (e.g., deduplicates any duplicated data blocks) as appropriate. Upon walking the entire slice file, the volume is updated to indicate successful transitioning to the new DPS.

If the transitioning process is interrupted for any reason (e.g., the process crashes), the slice service starts over at the beginning of the slice file and relies on the deduplication capabilities of the block services to process any blocks that may have previously been forwarded. Alternatively, an optimization of the technique may employ a checkpoint marker to the slice file to identify a point (position) of transition within the volume when the interrupt occurred, so that when the process is restarted, walking can resume at the marker position. Yet another optimization may involve creation of an immutable read-only copy (i.e., a snapshot) of the slice file prior to initiating the transitioning process to essentially isolate the old DPS-tagged blocks from the new incoming data blocks tagged with the new DPS. The slice service may then need only to walk the snapshotted slice file during the background transitioning process.

According to the technique, data blocks that are no longer in use by any volumes are cleaned up via the GC process. During the time between t1 and the point t2 in time when all data blocks tagged with either old or new DPS tags have been forwarded to the to block services, the slice service 360a inserts (adds) the block IDs for the volume into Bloom filters configured separately for both the old DPS and the new DPS. That is, the slice service sends different Bloom filters for each DPS enabled on the cluster to the block services. Once transitioning of the volume is completed, the GC process begins (initiates) and the block IDs are inserted to the Bloom filters for only the new DPS. In other words, any GC processing that occur after t2 only have block IDs added to the

Bloom filters for the new DPS. During this GC processing after t2, the block services remove block IDs from the Bloom filters for the old DPS in use by the volume (assuming those blocks are not in use by another volume with the old DPS). When the old DPS is no longer in use for a block, the block services react accordingly by either deleting the block or optimizing storage efficiency for the block, i.e., if the GC process determines that a fewer number of DPSs are using a block, the block services optimize storage efficiency through deduplication and/or erasure coding, accordingly (e.g., removal of TP from a volume using DP and TP). After the volume has transitioned from the old to new DPS, there are no data blocks tagged with the old DPS stored on the cluster because the GC process has deleted them (e.g., marked the data block unused).

For example, if a volume (i.e., Volume 1) contains data blocks that are being transitioned (converted) from an old DPS (i.e., TP) to a new DPS (i.e., DP), the slice services flush data blocks of all incoming write requests tagged with the new DPS in duplicates (for DP) and, in accordance with the technique, a slice service (i.e., slice service 360a) walks the entire slice file (i.e., slice file 610) of Volume 1 until the existing old TP-tagged blocks are retrieved and resent to the block services as new, DP-tagged blocks. The TP-tagged data blocks that are no longer in use by Volume 1 (i.e., TP-tagged. Block A of Bin 1-2) are cleaned up (deleted) by GC process 650, as denoted by X. Illustratively the GC process 650 cleans-up the old TP-tagged blocks by, e.g., comparing the DPS tags of the stored blocks and deleting the TP-tagged blocks, such that the cluster operates as if all blocks were written with the new DP-tagged DPS.

On the other hand, if the volume contains blocks that are being transitioned from an old (e.g., DP) to a new DPS (e.g., TP), the block services may deduplicate the data blocks accordingly to share as much of the persisted (stored) data as possible. Here, the to technique relies on the ability of the block services to intelligently deduplicate the data blocks of the replica-based bin assignments to determine that, e.g., successive write requests of the copy of the data block R0 for double and triple replication should only be stored once (one copy of RO) along with an indicator (e.g., a bit) associated with the RO data block denoting that the R0 data block is being used for both double and triple replication. When the GC process is invoked and the transition of the volume has completed such that the data blocks are no longer used for double replication, the indicator is removed for double replication and no additional data is freed.

While there have been shown and described illustrative embodiments for transitioning data blocks of a volume served by storage nodes of a storage cluster from a first DPS to a second DPS in a non-disruptive manner (i.e., without disconnecting the client from the volume during the transition), it is to be understood that various other adaptations and modifications may be made within the spirit and scope of the embodiments herein. For example, embodiments have been shown and described herein with relation to transitioning a volume containing data blocks converted from a first (old) replication-based DPS, such as triple replication, to a second (new) replication-based

DPS, such as double replication, and vice versa. However, the embodiments in their broader sense are not so limited, and may, in fact, allow for transitioning a volume containing a DPS other than replication. For instance, the embodiments may allow for transitioning a volume containing data blocks converted from an old replication-based DPS, such as double or triple replication, to a new erasure coding based DPS, and vice versa. In this instance, a block service (such as a master replica block service) may delete unencoded copies of data blocks in lieu of encoded parity blocks. Note that deletion of data block may embody removing an association of the data block indicating its use.

Advantageously, the technique described herein is directed to making the transition from the first DPS to the second DPS non-disruptively, i.e., a new volume is not required, the client is not required to disconnect and then reconnect to the volume, and there is substantially no performance impact.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Accordingly, is this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
storing data replicas on bin replicas distributed across storage nodes of a cluster, the bin replicas hosted on a plurality of block services of the storage nodes, the data replicas generated according to a first data protection scheme (DPS) of a volume storing data blocks of the data replicas tagged with the first DPS, the first DPS of the volume indicated by volume DPS information of a database in the cluster;
transitioning the volume from the first DPS to a second DPS at a first point in time (T1) by tagging data blocks of write requests received from a client at the cluster after T1 with the second DPS for storage on the volume;
updating the volume DPS information of the database to indicate the second DPS of the volume; and
converting the first DPS of the data blocks stored before T1 to use the second DPS as a background process without disconnecting the client from the volume.

2. The method of claim 1 wherein transitioning the volume from the first DPS to the second DPS further comprises generating additional or fewer of the bin replicas for assignment to the block services to support the second DPS of the volume.

3. The method of claim 1 further comprising managing metadata of a slice file associated with the volume at one or more slice services of the storage nodes, each slice service associated with a copy of the slice file, the metadata including a mapping of logical block addresses of the volume to block identifiers of the data blocks contained in the volume.

4. The method of claim 3 wherein managing the metadata of the slice file further comprises deleting a copy of the slice file associated with one of the slice services when
the second DPS has a decreased redundancy.

5. The method of claim 4 wherein converting the DPS of the data blocks stored before Ti to use the second DPS further comprises:
traversing the one or more slice files to read each data block tagged with the first DPS;
retagging each block and associated block ID with the second DPS; and
forwarding the retagged block and associated block ID to the block services.

6. The method of claim 1 wherein transitioning the volume is performed atomically at T1 by updating the volume DPS information in sequence with tagging the data blocks of the write requests with the second DPS.

7. The method of claim 6 further comprising adding block identifiers (IDs) associated with the tagged data blocks stored on the volume to filters configured for the first DPS and the second DPS, wherein the data blocks include first DPS tags and second DPS tags stored on the volume between T1 and a second point in time (T2) when the data blocks s tagged with the first or second DPS tags are forwarded to the block services.

8. The method of claim 7 further comprising, in response to completion of transitioning of the volume:
initiating garbage collection on the volume;
adding the block IDs to the filters associated with data blocks tagged with the second DPS;
removing the block IDs for data blocks tagged with the first DPS from the volume; and
one of deleting the data blocks tagged with the first DPS and optimizing storage efficiency for the data blocks tagged with the first DPS when the first DPS is no longer in use for the data blocks.

9. The method of claim 8 wherein optimizing for storage efficiency is performed by the block services through one of deduplication and erasure coding.

10. The method of claim 8 wherein the filters are Bloom filters.

11. The method of claim 1 wherein the first DPS is one of triple replication, double replication and erasure coding, and wherein the second DPS is one double replication, triple replication and erasure coding.

12. The method of claim 1 wherein converting the first DPS of the data blocks stored before T1 to use the second DPS further comprises intelligently deduplicating a first data replica of each data block according to the first DPS at the block services.

13. The method of claim 12 wherein the first data replica is associated with an indicator.

14. A cluster comprising:
a plurality of storage nodes each having a block service for storage on one or more storage devices coupled to a respective storage node;
each storage node including a processor configured to execute instructions to, store a plurality of data replicas on a plurality of bin replicas distributed across the cluster, the bin replicas hosted on the block services of the storage nodes, the data replicas generated according to a first data protection scheme (DPS) of the volume,
store data blocks of the data replicas tagged with the first DPS, the first DPS of the volume indicated by volume DPS information of a database in the cluster,
transition the volume from the first DPS to a second DPS at a first point in time (T1) by tagging data blocks of write requests received from a client at the cluster after T1 with the second DPS for storage on the volume,
update the volume DPS information of the database to indicate the second DPS of the volume, and
convert the first DPS of the data blocks stored before T1 to use the second DPS as a background process without disconnecting the client from the volume.

15. The system of claim 14 wherein the processor configured to execute instructions configured to convert the first DPS of the data blocks stored before T1 to use the second DPS is further configured to execute instructions to:
traverse metadata having a mapping of logical block addresses of the volume to block identifiers (ID) of the data blocks contained in the volume;
retag each block ID with the second DPS; and
forward each retagged block ID to the block services.

16. The system of claim 15 wherein the block services receiving each forwarded retagged block ID store a respective associated data block according to the second DPS.

17. The system of claim 15 wherein the block services receiving each forwarded retagged block ID store an associated first data replica of each data block once.

18. The system of claim 15 wherein the processor configured to execute instructions is further configured to execute instructions to add block identifiers (IDs) associated with the tagged data blocks stored on the volume to filters configured for the first DPS and the second DPS, wherein the data blocks include first DPS tags and second DPS tags stored on the volume between T1 and a second point in time (T2) when the data blocks tagged with the first or second DPS tags are forwarded to the block services.

19. The system of claim 18 wherein the processor configured to execute instructions is further configured to execute instructions to, in response to completion of transitioning of the volume:
initiate garbage collection on the volume;
insert the block IDs to the filters for only data blocks tagged with the second DPS;
remove the block IDs for data blocks tagged with the first DPS from the volume; and
one of delete the data blocks tagged with the first DPS and optimize storage efficiency for the data blocks tagged with the first DPS when the first DPS is no longer in use for the data blocks.

20. A non-transitory computer readable medium having program instructions configured to:
store a plurality of data replicas on a plurality of bin replicas distributed across storage nodes of a cluster, the bin replicas hosted on a plurality of block services of the storage nodes, the data replicas generated according to a first data protection scheme (DPS) of the volume storing data blocks of the data replicas tagged with the first DPS, the first DPS of the volume indicated by volume DPS information of a database in the cluster;
transition the volume from the first DPS to a second DPS at a first point in time (T1) by tagging data blocks of write requests received from a client at the cluster after T1 with the second DPS for storage on the volume;
update the volume DPS information of the database to indicate the second DPS of the volume; and
convert the first DPS of the data blocks stored before T1 to use the second DPS as a background process without disconnecting the client from the volume.
